(19) United States
(12) Patent Application Publication
(10) Pub. No.: US 2016/0332896 A1
(43) Pub. Date: Nov. 17, 2016

(54) METHOD AND ASSOCIATED APPARATUS FOR PROCESS WATER SANITATION

(71) Applicant: AQANAT LIMITED, York Yorkshire (GB)

(72) Inventor: Ciro ZAVANELLA, York (GB)

(73) Assignee: Aqanat Limited

(21) Appl. No.: 15/107,215

(22) PCT Filed: Dec. 19, 2014
(86) PCT No.: PCT/IB2014/067119

§ 371 Date: Jun. 22, 2016

(30) Foreign Application Priority Data
Dec. 24, 2013 (IT) MI2013A002205

(51) Int. Cl. C02F 1/467; C02F 1/461; B08B 3/14; A23B 7/158; B08B 9/08; B08B 3/08; C02F 1/00; A23N 12/02

(52) U.S. Cl. CPC C02F 1/4672; C02F 1/001; C02F 1/46109; A23N 12/02; A23B 7/158; B08B 9/08; B08B 3/08; B08B 3/14; C02F 2001/46147; C02F 2103/32

(57) ABSTRACT

Sanitizing method for eliminating microorganisms from washing/process water used for fruit and vegetable produce, comprising the steps of: filtering of the process water; electrolysis of the filtered process water in at least one electrolytic cell; turbulence promotion of the process water flow inside the at least one electrolytic cell, performed by providing the cell (s) with turbulence promoters; and wherein the electrolysis step is performed in (an) electrolytic cell (s) provided with BBD (Boron Doped Diamond) electrodes.

The present invention relates to a method and an associated apparatus for process water sanitation, in particular water used for washing fruit and vegetable produce in post-harvest treatment and/or packing plants.

The need for said process water sanitation is known to exist in the technical sector for the treatment and packaging of fruit and vegetable produce, such as citrus fruits, where said produce, is transported after harvest inside containers (crates and/or bins) to special plants where the harvested fruit and vegetable products undergo washing and, at the same time and/or subsequently, treatment with suitable chemical plant protection products and/or biocidal agents to ensure the neutralization of the microorganisms, of a pathogenic or non-pathogenic nature, in particular fungi and bacteria, that may be responsible for post-harvest moulds affecting the fruit and vegetable products or rendering the produce unmarketable owing to an excessive degree of microbiological contamination, as in the case of fresh-cut (fourth range) fruit and vegetable products, also referred to as “ready to eat”.

Such microbiological pathologies and contamination are at present responsible for the most important losses in the fruit and vegetable industry since they cause a large percentage of the harvested produce to become unmarketable.

For many years chemical substances for conventional post-harvest treatment have consisted mainly of chemical fungicides such as, in the case of citrus and pome fruits for example, Imazalil, Thiabendazole (TBZ), Ortho-phenylphenol (OPP), applied as a wax treatment or directly into the fruit and vegetable washing tanks, for controlling the moulds caused by Penicillium spp. and Geotrichum spp., or of other chlorine-based biocidal and disinfecting agents, which are widely used to ensure hygiene during the processing of fresh, ready-to-eat, vegetable food products, namely fresh-cut fruit and vegetable products, and for controlling, among other microorganisms, Escherichia spp., Salmonella spp. and Listeria spp. It is also known, in the sector, that the washing of fruit and vegetable products is performed mainly in specially designed washing tanks through which the products flows, entering and exiting in a continuous cycle. If adequate sanitation measures are not taken during fruit and vegetable post harvest treatment operations performed in washing tanks and along the entire treatment and packaging line, major problems associated with microbiological contamination and inoculum accumulation may arise, these requiring frequent renewal of the process water and the application of chemicals in order to maintain the disinfection and hygiene/sanitary parameters at the level required by commercial standards and prevent cross-contamination of healthy fruit and vegetable produce.

Examples of the prior art which make use of chlorine-based chemical agents are described in WO 2006/052 130 A1, JP 2004 223 317 A and ES 2 185 491 A1 which describe processes for sanitation of the washing water for vegetable processing by means of a filtering step followed by a step involving electrolysis of the filtered water, which water has been previously added with chemical precursors (for example potassium chloride) which are oxidised to chlorine in an electrochemical cell, obtaining a sanitized and sanitizing water with active chlorine.

These methods require the use of chemical precursor agents which are oxidised to chlorine and constant monitoring of the quantity of free chlorine in process waters, which must not exceed well-defined limits laid down by law.

A further problem associated with these known methods arises from the fact that, although chlorine is a biocide commonly used in post-harvest washing of fruit and vegetable products where chemical treatments are permitted, the biocidal effect of chlorine, however, rapidly deteriorates in presence of a high level of organic loads or high C.O.D. (Chemical Oxygen Demand) in the washing water; under these conditions in fact the biocidal effect of the chlorine generated in situ as a result of electrolysis deteriorates very rapidly and, instead, dangerous organochlorinated by-products which are harmful for human health are formed, these requiring frequent renewal of the processing water with a consequent wastage of both water and energy resources, along with production of sludges and waste water which are difficult to dispose of owing to the presence of chemical agents.

In addition, new high value-added markets, based on sustainable, environmentally friendly, organic fruit and vegetable crops, are becoming increasingly popular, resulting in a clear and growing need to develop and implement methods for disinfecting, controlling and preventing post-harvesting pathologies and microbiological contamination in fruit and vegetable products, which are able to provide an alternative to the use of synthetic chemical products and allow the production of more natural foods which do not have traces of toxic residues and are therefore healthier.

WO 2012/156438 A1 describes a method for post-harvest treatment of citrus fruit comprising:
a step where the citrus fruit is brought into contact with the washing water;
a step for electrolysis of said washing water, in which BDD (Boron Doped Diamond) electrodes are preferably used;
a step involving the use of said water which has undergone electrolysis for washing citrus fruit.

The method may be implemented also without the addition of chemical precursors based on chlorides or other salts, but requires the washing water to be brought into contact beforehand with the citrus fruit in order to release from the peel thereof soluble organic compounds, such as nariturin or hesperidin, which are considered to be effective fungicides. This results in the need to maintain an undesirable high level of dissolved organic substance and therefore a high COD level in the washing water, which results in an increase in the population of pathogenic organisms in the treated water and preventing prior filtering of said washing water, to the detriment of the electrochemical process and the washing effiency of said process water.

In addition to the above, in order to achieve a suitable level of dissolved organic substance (COD) in the water, it is necessary to perform preliminary washing cycles of the citrus fruit with “pure” water free of spores, whose presence during this preliminary washing step could result in an accumulation of microorganisms potentially damaging for the post-harvest conservation of the fruit and vegetables.

Further problems associated with the presence of pathogenic microorganisms consist in the need to wash also the containers for the fruit and vegetable products, before any re-use, in order to prevent cross-contamination of subsequent product batches with potentially damaging inoculum sources during post-harvest storage of said produce.

The technical problem which is posed, therefore, is that of developing a method for in situ sanitition of washing/process water for fruit and vegetable products which does not involve the use of chemicals and/or fungicides and which ensures efficient washing of the produce and sanitization of the process water, avoiding microorganism population build up in washing tanks and along the entire treatment/packaging line.

In this connection it is also desirable that the sanitation method should allow the packaging of fruit and vegetable produce without the addition of further chemical substances beyond those which are permitted in crops pre-harvest and/or with the production of inert sludges which can be easily spread/dispersed or otherwise disposed of in accordance with applicable regulations for environmental protection.

In connection with this problem, it is also required in particular that the method should allow the disinfection capacity of the process water inside the washing tank to be kept at the desired level without, however, requiring the frequent replacement of said process water and therefore avoiding wastage of the water which in the harvesting zones (usually situated in hot/tropical climatic areas) constitutes a precious commodity.

In addition to the above it is also desirable that the method should be able to be implemented by means of plants with a simple constructional design which may be easily installed along the lines for treatment/packaging of the fruit and vegetable products, which are usually situated in agricultural zones and in which the space is limited.

These results are obtained according to the present invention by a sanitation method according to the characteristic features of claim 1, by a corresponding apparatus according to claim 16 and by a plant for the post-harvest treatment of fruit and vegetable products according to the characteristic features of claim 23.

Further details may be obtained from the following description of non-limiting examples of embodiment of the subject of the present invention, provided with reference to the accompanying drawings, in which:

FIG. 1: shows a block diagram illustrating the process sequences of the method according to the invention;

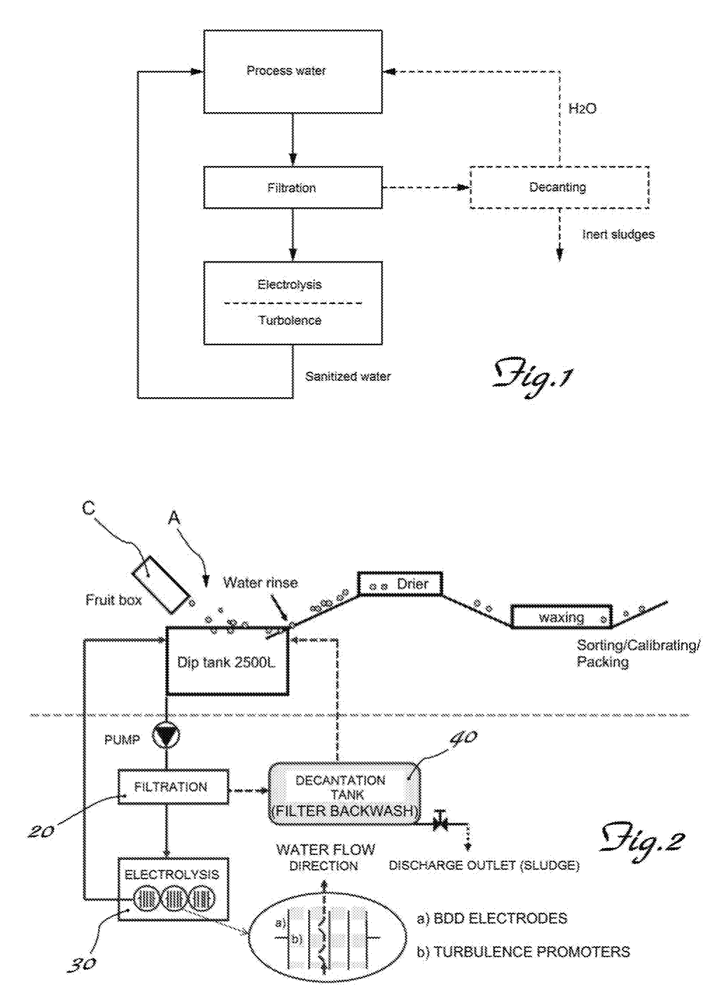

FIG. 2: shows a block diagram illustrating the process sequences of the method according to the invention, applied to a tank for the treatment of citrus fruit;

FIG. 3: shows a schematic side view of a first example of a plant for implementing the method according to the present invention, inserted along a line for the post-harvest treatment of citrus fruits;

FIG. 4: shows a perspective view of an example of embodiment of a sanitation apparatus according to the invention;

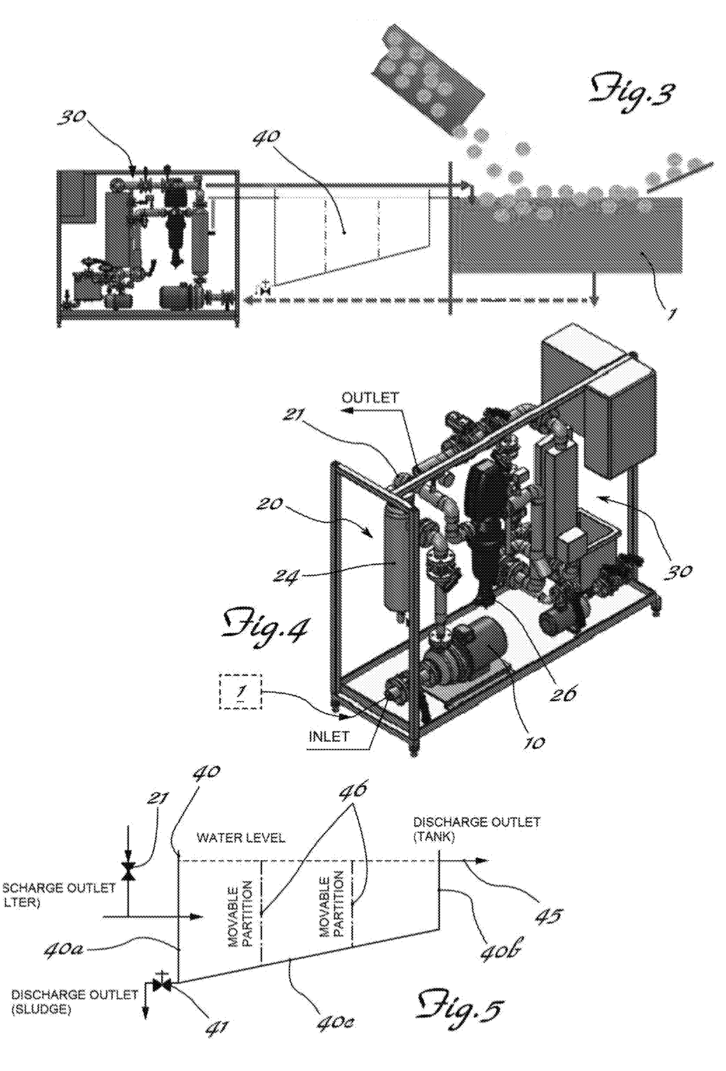

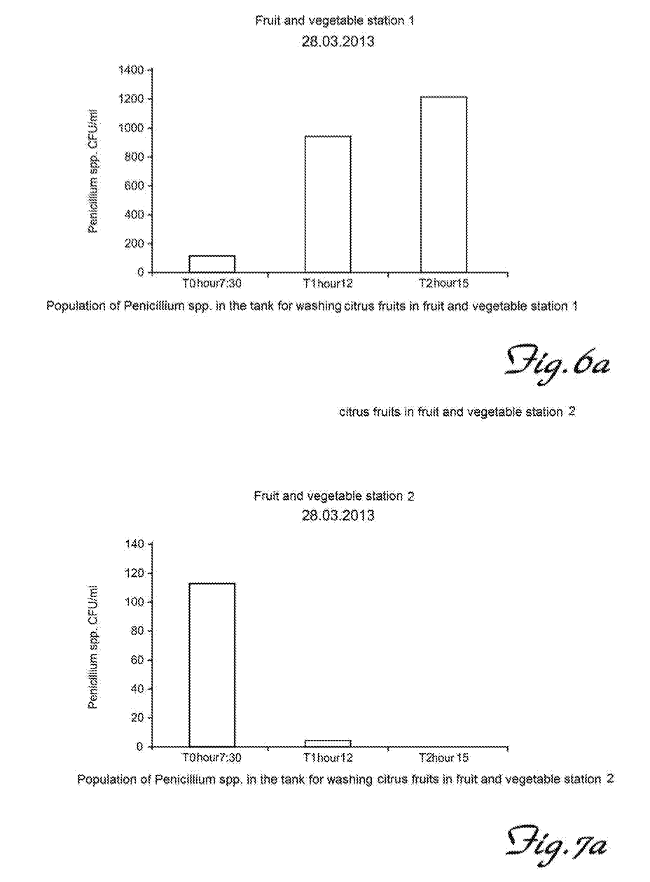

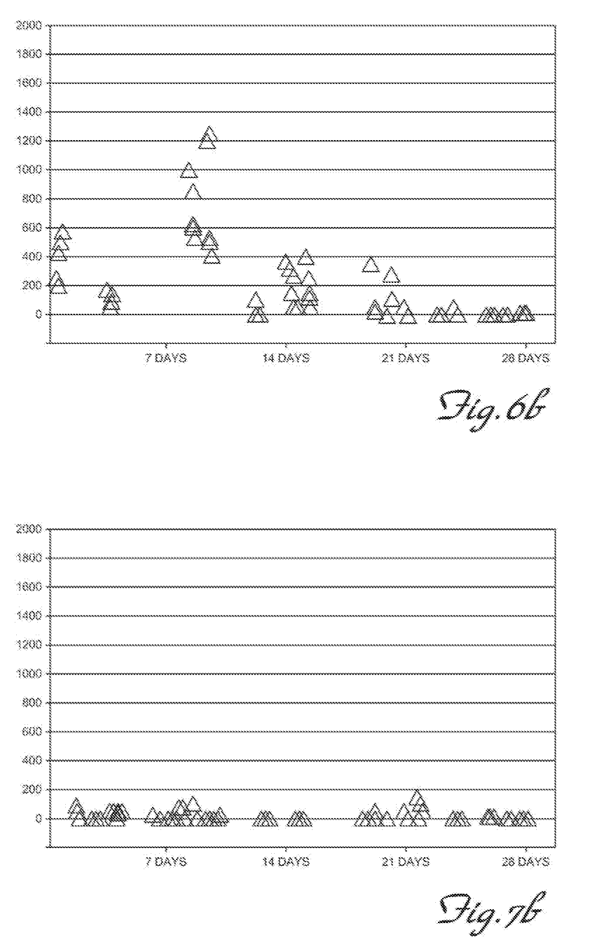

FIG. 5: shows a cross-sectional view of an example of embodiment of a decanter tank for use with the apparatus according to FIG. 3;

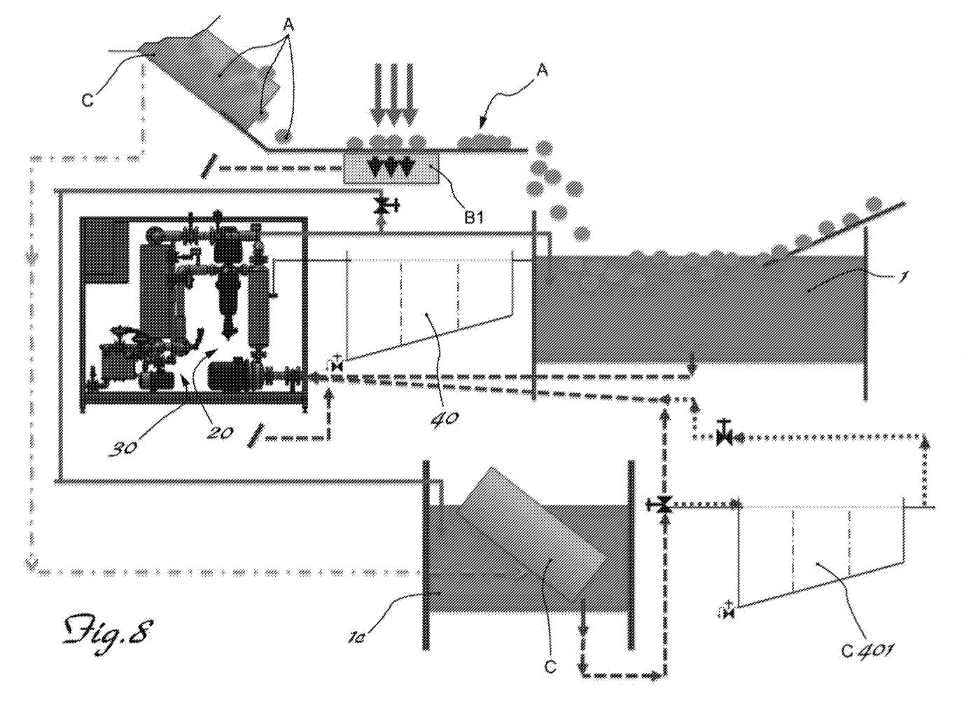

FIGS. 6a, 6b: show graphs illustrating the microorganism population at different sampling times for the washing water in a fruit and vegetable station without the present invention;

FIG. 7a, 7b: show graphs illustrating the microorganism population at different sampling times for the washing water in a fruit and vegetable station provided with a sanitation plant according to the present invention;

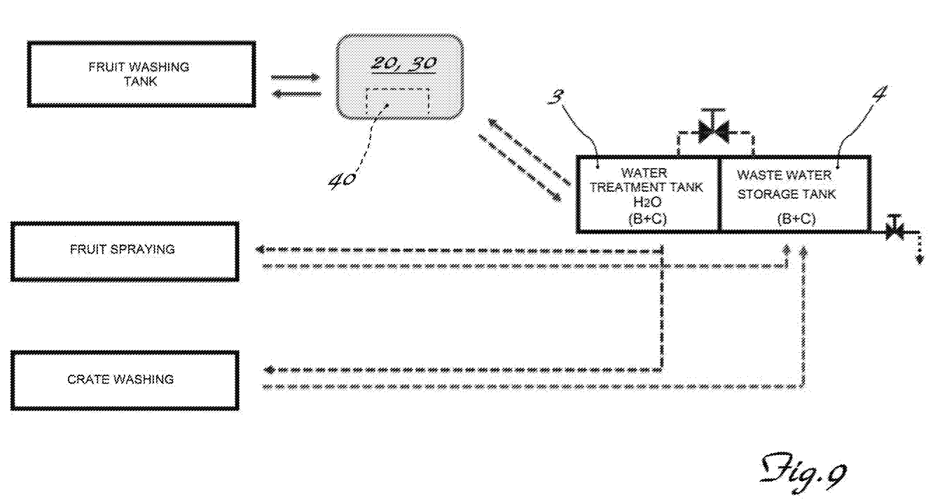

FIG. 8: shows a schematic illustration of a further embodiment of a plant for sanitation of process water according to the invention;

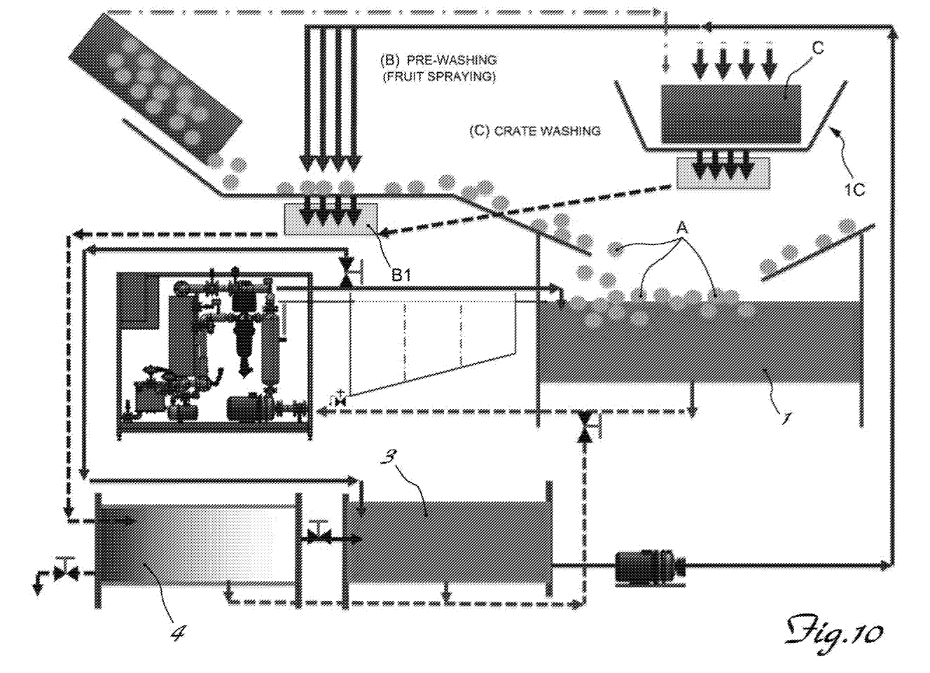

FIG. 9: shows a block diagram of a mode for implementing a variation of the method according to the invention; and

FIG. 10: shows a schematic illustration of a further embodiment of a plant for sanitation of process water according to the invention.

As shown in FIG. 1, a method according to the invention for the sanitation of water used to wash fruit and vegetable produce, with neutralization of the pathogenic microorganisms present therein, comprises the following basic steps:
filtering of the process water (1);
electrolysis of the filtered process water in at least one electrolytic cell; and
turbulence promotion of the water flow in the electrolytic cell(s).

It has been observed by the Applicant that, by means of the electrolysis of the pre-filtered water, facilitated by the turbulent flow, it is possible to obtain a rapid microbiotic neutralization of the non-filtered pathogenic microorganisms which are responsible for the moulds in fruit and vegetable products and therefore correct sanitization of the water by means of a physical process.

The electrolysis step is performed in electrolytic cells provided with boron doped diamond (BDD) electrodes. The Applicant has in fact observed that this mode of implementation, in combination with the turbulent flow promoted in the at least one electrochemical cell, ensures an improved biological neutralization, in particular directly on the surface of the BDD electrode.

In a preferred embodiment of the method according to the invention the following further step is also envisaged:
reusing the electrolytically treated water as washing/process water for fruit and vegetable products.

By reusing the water it is possible to obtain a closed continuous cycle during which the water is continuously removed, sanitized and reused for washing or treatment, thus eliminating any wastage of process water.

In greater detail and with reference to FIG. 2, a method according to the invention, for example applied to the process water in a tank 1 for washing fruit and vegetable products A, may comprise the following steps:
removal of the water for washing the fruit and vegetable products from the tank 1 through which the products pass and exit free from the pathogenic microorganisms now dissolved in the washing water;
filtering of the removed washing/process water;
supplying of the filtered process water to at least one electrolytic cell 30, preferably provided with boron doped diamond (BDD) electrodes;
electrolysis of the process water in the at least one electrolytic cell along with
simultaneous promotion of a turbulent flow inside the at least one electrolytic cell;
supplying of the electrolytically treated water to the tank 1 for washing the fruit and vegetable products.

A closed continuous cycle is therefore obtained where the water is continuously removed from the tank, sanitized and reintroduced into the washing tank, thereby eliminating any wastage of process water and the accumulation of pathogenic microorganisms following the continuous washing of the fruit and vegetables.

Preferably, during the filtering step, all the bodies with a size greater than 5 times, and preferably greater than 8 times, the diameter of the target pathogenic microorganisms are filtered. As a result it is possible to obtain a micro-filtrate which improves the efficiency of the subsequent electrolysis step.

Preferably the filtration is performed in two sequential substeps, so as to prevent blockage of the filters due to the presence of water charged with coarse inert particles such as sand and silt. In particular, during the first filtering step, sand and coarser inert particles may be removed, while the second filtration step may be adapted for the removal of the finer inert particles.

The step of promotion of the turbulent flow in the electrolytic cell(s) is preferably performed by providing said cell with suitable turbulence promoters. Examples of these promoters will be described in greater detail below.

Also envisaged is a further/complementary step of decanting of the filtrate resulting from the filtration step, in order to limit the wastage and obtain further sanitized water to be conveyed back to the washing tank, as well as an inert residual sludge to be conveyed away for disposal.

With reference to that shown in FIGS. 2 and 3 a preferred embodiment of the method according to the invention is applied to a plant for the treatment and packaging of citrus fruits. It is known that the main pathogenic microorganism responsible for post-harvest moulds in citrus fruits is Penicillium spp (Penicillium digitatum, Penicillium italicum) and, secondarily, Geotrichum spp. which have an average diameter of 10μm. In the embodiment shown the process water is filtered so as to reduce the content of inert particles such as sand and silt with a diameter of about 1 mm, and preferably between 50μ e 500μ, before subjecting the filtered liquid to an electrochemical treatment.

Preferably the filtering system is connected to a decanting tank 40 which receives the filtration residue and sends the clean water, via the overflow outlet, back to the washing tank 1.

It is envisaged moreover that the electrolysis step of the method is preferably performed by means of boron doped diamond (BDD) electrodes, preferably obtained by means of a CVD (Chemical Vapour Deposition) process. The diamond film is deposited on a suitable surface as a continuous layer with a thickness of between 1 μm and 50 μm. The substrate may consist of silicon and/or a metal substrate such as niobium, tantalum, titanium and zirconium. The electrolysis step is preferably performed in electrochemical cells characterized by a total electrode surface area of between 0.002 and 2 m²/m³ of process water, and preferably between 0.05 and 1 m²/m³. This ensures that there is sufficient electrolytic capacity of the cell in relation to the quantity of water to be treated and sanitized. The gap between the electrodes may be preferably between 0.5 and 5 mm.

The turbulence in the electrochemical cells may be promoted using any means suitable for upsetting the laminar flow of the washing water, favouring the creation of vortices, turbulence or a disorderly flow inside the cell; in this way the turbulent flow is made to favour the contact between the surface of the BDD electrodes, where highly oxidising radicals (ROS-Reactive Oxygen Species) such as *OH′ O₃, H₂O₂, O₂⁻ and the waters to be sanitized are generated, ensuring a high efficiency of the sanitization process. In particular the neutralization of the pathogenic microorganisms directly on the surface of the electrode is favoured.

According to the invention, a surprisingly efficient sanitizing effect is associated with the synergic action of the turbulence promoters together with the high oxidising power of the OH radicals generated by the diamond electrodes, resulting in oxidative reactions at the level of the proteins and obtaining on the surface of the electrode a biocidal and fungicidal action by means of protein denaturation of the cellular wall of the fungi and bacteria, without the need for biocidal or fungicidal agents. The use of boron doped diamond (BDD) electrodes has proved to be particularly effective for this purpose.

Preferably the turbulence promoters consist of inert materials such as polypropylene or metals fixed suitably on the surface of the electrode or in the interspaces between the electrodes. Preferably the promoters may be formed by monofilament fabrics made of inert and strong polymeric material such as polypropylene. With these embodiments it is possible to obtain easily effective promotion of the turbulent flow inside the electrolytic cell, thereby obtaining improved sanitization of the previously filtered process water.

The electrolysis is generally performed with or without inversion of polarity, with a current density preferably ranging between 10 mA/cm² and 200 mA/cm².

The method according to the invention moreover has the advantage that it may be applied irrespective of the chemical or microbiological quality of the process water—and more specifically of the COD (Chemical Oxygen Demand) level—which does not interfere with the outcome of the treatment according to the proposed method.

Although described as water of a washing tank, the sanitized process water according to the method of the present invention may likewise be used for washing fruit and vegetable produce by means of immersion or spraying. As described further below it is also possible to use the treated water for cleaning/washing the packaging line; the method according to the invention in fact does not require for the water to come into contact beforehand with the citrus fruit or other fruit and vegetable produce. According to the proposed method, the process water is treated in a closed cycle without wastage and/or the need for renewal, apart from the water consumption due to contact with the fruit and vegetable produce and the disposal of small quantities of sludge which have accumulated in the decanter tanks.

With reference to FIG. 4, an apparatus for sanitazing process waters of fruit and vegetable produce which implements the method according to the present invention is described below. In the embodiment shown the plant substantially comprises:
a pump 10 for drawing the process water from the washing tank 1, schematically indicated by means of a broken line in FIG. 4;
a filtering device 20 connected to the delivery of the pump 10;
a first valve 21 connected to the outlet of the filtering device for through-flow of filtered water; and
a second valve 22 for discharging the filtrate/residue of the filtering operation;
a unit 30 for electrolytic treatment of the filtered water supplied via the said first flow valve 21; said unit 30 comprises at least one electrolytic cell provided with diamond electrodes preferably doped with boron (BDD electrodes) and with elements for promoting turbulence of the water flow inside the electrolytic cell.

According to preferred aspects of the invention the plant may furthermore comprise:
a decanter tank 40 supplied via the said discharge valve 22 with the filtration residue; the tank 40 also has a bottom valve for discharging the separated sludge to be conveyed away for disposal as well as an upper overflow outlet 45 for conveying the clean water back to the washing tank 1; in this case the decanter tank is preferably situated at a height greater than that of the washing tank. The decanter tank may optionally also receive upstream or recovered agricultural washing water, so that the water cycle is closed and without wastage.

An example of a preferred embodiment of such a decanter tank is illustrated in FIG. 5. As shown, the tank has an inlet side 40a for the sludge resulting from the filtering system and an outlet side 40b for the water. The tank has the cross-sectional form of a rectangular trapezium with a bottom surface 40c inclined from the bottom upwards and from the side for entry of the waste sludge to the water outlet side.

The tank may moreover comprise movable partitions arranged vertically and designed to ensure further separation of the dry part of the filtrate—which is retained in the tank for discharging via the valve 40—from the water to be supplied again to the washing line via the overflow outlet 45.

The filtering system 30 may further comprise a first filtering stage 24, for removing sand and coarser inert particles, and a second filtering stage 26 consisting of an automatic self-cleaning filter with a filter cartridge suitable for removal of the finer inert particles.

In this case said valve 22 for performing discharging towards the decanter tank is connected to both filtration stages 24-26, while the filtered water is supplied via the valve 21 to the second filtering stage 26 and from here to the electrochemical cells.

According to the invention it is envisaged in a preferred embodiment that the electrodes used for the electrolytic treatment consist of BBD electrodes, i.e. diamond electrodes doped with boron by means of a CVD (Chemical Vapour Deposition) process.

A characteristic feature of the electrochemical cell is furthermore the insertion of means designed to generate turbulence of the electrolyte, said means preferably consisting of inert materials such as polypropylene or metals suitably fixed on the surface of the electrode or between the electrodes. FIGS. 6 and 7 illustrate respectively results obtained with sanitation performed using a method according to the prior art and using the method according to the present invention.

### Example No. 1

FIG. 6a shows a graph illustrating the population of Penicillium spp. (expressed in CFU/ml, i.e. colony forming units per unit of volume) at different times for sampling of the washing water of a fruit and vegetable station where the washing water has been treated without incorporation of the present invention. For comparison purposes, two similar fruit and vegetable stations characterized by an identical size of the washing tank (about 3 m³) were chosen. Furthermore 3 daily water samples were taken for recording the population at the times T0, T1 and T2 after replacement of the tank water in both the plants at the time T0. It is known that a population threshold value greater than 100 CFU (Colony Forming Units)/ml is able to infect healthy fruit during washing inside the tank.

FIG. 7a shows a graph illustrating the population of Penicillium spp. (CFU/ml, i.e. colony forming units per unit of volume) at different times for sampling of the washing water of a fruit and vegetable station where the washing water has been treated using the method of the present invention.

it is therefore clear how the method according to the invention ensures rapid neutralization of the pathogenic microorganisms and the availability of constantly sanitized water inside the washing tank.

### Example No. 2

FIGS. 6b, 7b show the results of a similar experimental test carried out over a period of several days (about thirty); FIG. 6b shows the microbic population inside the tank without treatment according to the invention: in this tank the washing water has been regularly replaced during the entire observation period, at an interval of 3-7 days depending on the microbiological contamination of the citrus fruit batches and moreover with the addition of sodium bicarbonate (a fungistatic salt) during treatment of batches of fruit in particular contaminated with Penicillum spp.

FIG. 7b shows the microbial population inside the tank connected to an apparatus which implements the sanitization method according to the invention; the water in this tank has been sanitized in the manner described and never replaced during the entire observation period of more than 30 days.

It is therefore clear how the method according to the invention ensures the correct sanitization of the washing water also for long periods of activity of the treatment station, without wastage of process water, and with a reduction in the plant downtimes for replacement thereof.

It is therefore clear how the method according to the invention ensures the correct sanitization of the washing water also for long periods of activity of the treatment station.

According to preferred embodiments of the apparatus according to the invention which implements the method described, control and operating means are provided, which means may have, singly or in combination, the following characteristic features:
manual or timed operation of the plant;
automatic control of filtration preferably performed by means of the backwashing of the filters activated by a pressure gauge depending on the difference in the filter entry and exit pressures.
automatic control of electrolysis, which in the case of stoppage of the flow in the electrochemical cell automatically switches off the power supply (e.g. a potentiometer) of the electrochemical cell, triggering an alarm signal;
the control system presets the plant for default operation at the maximum power (e.g. 200 mA/cm² of electrode);
the apparatus may also have a setting for automatic backwashing of the electrochemical cell UNDER ZERO LOAD (after stoppage of the potentiometer and therefore electrolysis) using alimentary citric acid; preferably the backwashing is triggered automatically depending on a signal received from a pressure gauge which measures the pressure inside the cell, preferably when the pressure exceeds 1 bar.

In a further preferred embodiment of the method according to the invention, schematically shown in FIG. 8, it is envisaged that the water to be sanitized also includes water used for pre-washing B of the products and/or for washing of the containers C.

According to a first embodiment (FIG. 8) in which sanitization of the water for pre-washing/washing the containers occurs at the same time as/in parallel with sanitization of the process water, the method may, for example, comprise the following steps:
removal of the water for washing the fruit and vegetable produce from the associated tank 1 through which the products pass and exit free from pathogenic microorganisms now dissolved in the washing water;
simultaneous removal of the water for washing the containers from an associated tank 10 for washing the containers C and/or of the water for pre-washing the products from an associated header B1;
filtering of the removed washing/process water;
supplying of the filtered process water to at least one electrolytic cell 30, preferably provided with boron doped diamond (BDD) electrodes;
electrolysis of the process water in the electrolytic cell along with simultaneous promotion of the turbulent flow inside the at least one electrolytic cell;
supplying of the electrolytically treated water to the tank 1 for washing the fruit and vegetable produce, to the tank 10 for washing the containers and to the means B for pre-washing the fruit and vegetable products A.

With this solution it is possible to obtain an integrated closed cycle in which also the water for pre-washing the fruit and vegetable products and for washing the product containers is sanitized and reused continuously, without any wastage of water.

According to a further embodiment of the method described above, it is envisaged that the control means give priority to sanitation of the water for treatment of the fruit and vegetable products, modulating therefore sanitation of the container pre-washing/washing water and pre-washing and/or washing of the containers so as to ensure the correct continuous sanitization of the water inside the fruit washing tank during the washing cycle, optionally supplying the container spraying and/or washing waste water to an associated storage tank C401 (schematically shown in FIG. 8), pending treatment.

According to a further preferred embodiment, schematically illustrated in FIGS. 9 and 10, it is envisaged that the method is implemented by means of two processing cycles which are carried out at different times (for example a day-time cycle and a night-time cycle).

1) First cycle (DAY-TIME): sanitization of washing water as described with reference to FIGS. 1 and 2, with simultaneous pre-washing of the products and containers with sanitized water supplied from a tank 3 for storing previously sanitized water and collecting the waste water from pre-washing of the products and washing of the containers in a special secondary tank 4 for collecting the waste water;

2) Second cycle (NIGHT-TIME): sanitation of the waste water collected inside the secondary tank and storage of the sanitized water in the said sanitized water storage tank.

This thus results in an integrated cycle which optimizes the time needed and the quantity of water used/sanitized, with the advantages of ensuring more efficient post-harvest treatment and optimum packaging of the fruit and vegetable produce from the microbiological point of view.

The water collected inside the storage tank 4 may be supplied directly to the sanitation apparatus or be first transferred into the storage tank 3 for the sanitized water, the plant illustrated by way of example in FIG. 10 showing a predisposition for both solutions. The tank 4 may also be provided with a valve 4a for discharging a residual sludge.

It is therefore clear how the method according to the invention allows for sanitation for treating fruit and vegetable products using physical means and without the need to use chemical products. Owing to recirculation of the sanitized water it is possible to obtain a closed treatment and sanitation cycle without wastage of process water.

The further embodiments shown, where pre-washing of the products and washing of the containers may also be performed, allow the formation of highly integrated treatment and packaging lines which do not waste water and which ensure constant sanitation of the process water.

Although described in connection with a number of embodiments and a number of preferred examples of implementation of the invention, it is understood that the scope of protection of the present patent is determined solely by the following claims.

1. A Sanitizing method for eliminating microorganisms from washing/process water used for fruit and vegetable produce, without the use of chloride-based precursors and chemical products, comprising the following steps:
filtering of the process water;
electrolysis of the filtered process water in at least one electrolytic cell; and
turbulence promotion of the process water flow inside the at least one electrolytic cell, performed by providing the cell(s) with turbulence promoters;
wherein the electrolysis step is performed in (an) electrolytic cell(s) provided with BBD (Boron Doped Diamond) electrodes.

2. The Sanitizing method according to claim 1, further comprising the step of:
reusing the washing/process electrolytically treated water as washing/process water for fruit and vegetable products.

3. The Sanitizing method according to claim 2, wherein the method is a closed continuous cycle during which the washing/process water is continuously removed, sanitized and reused for washing or treatment of fruit and vegetable products.

4. The Sanitizing method according to claim 1,
wherein the washing/process water is the water stored in at least one tank (1) for washing fruit and vegetable products (A), and
the method further comprises the following steps:
removal of the water for washing the fruit and vegetable products (A) from the at least one tank (1) through which the products (A) pass and exit free from pathogenic microorganisms which are dissolved in the washing water;
filtering of the removed washing/process water;
supplying of the filtered process water to at least one electrolytic cell (30);
electrolysis of the process water in the at least one electrolytic cell along with simultaneous turbulence promotion of the flow inside the at least one electrolytic cell; and
supplying of the electrolytically treated water to the tank (1) for washing the fruit and vegetable products.

5. The Sanitizing method according to claim 1, wherein, during the filtration step, all the bodies with a size greater than or equal to five times the diameter of the target pathogenic microorganisms are filtered.

6. The Sanitizing method according to claim 1, wherein the filtration is performed in the following two sequential substeps: a first step for filtering sand and coarser inert particles and a second step for filtering finer inert particles.

7. The Method according to claim 1, further comprising the step of decanting of the filtrate resulting from the filtration step, obtaining further recycled water and an inert residual sludge.

8. The Method according to claim 1, wherein:
the electrolysis step is performed in electrochemical cells with a total electrode surface area of between 0.002 and 2 m² /m³, preferably between 0.05 and 1 m² /m³ of process water; and
the gap/interspace between the electrodes is between 0.5 and 5 mm.

9. The Method according to claim 1, wherein the water to be sanitized comprises process/treatment water for the fruit and vegetable products (A) and water resulting from pre-washing (B) of the products and/or washing of containers (C) used for transportation of the fruit and vegetable produce.

10. The Method according to claim 1
further comprising the following preliminary steps:
removal of the water for washing the fruit and vegetable produce (A) from the at least one tank (1) for washing said products; and
simultaneous removal of:
the water for washing the containers from an associated tank (IC) for washing the containers (C), and/or
the water for pre-washing the fruit and vegetable produce (A) from an associated collector vessel (B1); and
further comprising the following final step:
supplying the electrolytically treated water to the tank (1) for washing the fruit and vegetable products, to the tank (1C) for washing the containers (C) and to the means (B) for pre-washing the fruit and vegetable produce (A).

11. The Method according to claim 10, wherein the method is carried out with:
a first cycle comprising the steps of:
sanitization of the water for washing the fruit and vegetable produce (A),
with simultaneous pre-washing (B) of the produce and washing of the containers (C) using sanitized water supplied from a tank (3) for storing previously sanitized water, and
collection of the waste water from pre-washing of the products and washing of the containers inside a special secondary waste-water collection tank (4); and
a second cycle comprising the steps of:
sanitation of the waste water collected inside the secondary tank (4), and
storage of the sanitized water inside the said sanitized water storage tank (3);
wherein said first and second processing cycles are performed at different times.

12. The Method according to claim 1, wherein the water to be sanitized consists of water for the treatment of citrus fruits.

13. The Method according to claim 1 wherein the target microorganisms are Penicillium spp (Penicillium digitatum, Penicillium italicum) and/or Geotrichum spp.

14. A Sanitation apparatus for eliminating microorganisms from washing/process water used for fruit and vegetable produce, comprising:
a pump (10) for suction of the process water;
a filtration device (20) connected to the delivery side of the pump (10);
a unit (30) for electrolytic treatment of the filtered water;
wherein said unit (30) comprises at least one electrolytic cell provided with means for promoting the turbulence of the water flow inside the electrolytic cell, and wherein the at least one electrochemical cell of said electrolysis unit (30) comprises boron doped diamond (BDD) electrodes.

15. The Apparatus according to claim 1, further comprising:
a first valve (21) connected to the outlet of the filtration device, for supplying the filtered water to the electrolysis unit (30); and
a second valve (22) for discharging the filtrate/residue of filtration.

16. The Apparatus according to claim 1, further comprising a tank (40) for decanting the filtrate of the filtration device (20).

17. The Apparatus according to claim 1, wherein the filtration device (20) comprises a first filtration stage (24), for removal of sand and coarser inert particles, and a second filtration stage (26) consisting of a self-cleaning automatic filter with filtering cartridge, suitable for removing the finer inert particles.

18. The Apparatus according to claim 1, wherein said turbulence promotion means consist of inert materials, such as polypropylene or metals, which are suitably fixed on the surface of the electrode and/or between the electrodes.

19. The Apparatus according to claim 1, wherein
the electrolytic treatment unit (30) has a total electrode surface area of between 0.002 and 2 m²/m³ of process water; and/or
the gap/interspace between the electrodes is between 0.5 and 5 mm.

20. A Post-harvest treatment plant for fruit and vegetable produce, comprising:
at least one tank (1) containing water for treatment of the fruit and vegetable produce;
an apparatus for sanitation of the process water of the at least one tank (1) according to claim 16.

21. The Plant according to claim 20 further comprising means (B) for pre-washing the fruit and vegetable products and/or means for washing containers (C) for transporting the fruit and vegetable produce (A).

22. The Plant according to claim 21 wherein said pre-washing means (B) and/or said means for washing the containers (C) are supplied with sanitized water by means of the sanitization apparatus.

23. The Plant according to claim 21, wherein the waste water from the said pre-washing means (B) and/or from said means for washing the containers (C) are sanitized by means of the sanitization apparatus.

24. The Plant according to claim 23 wherein the plant is designed to perform said sanitization of the waste water of the pre-washing means (B) and/or of the means for washing the containers (C) at the same time as sanitation of the process water of the at least one tank (1) for washing the fruit and vegetable produce (A).

25. The Plant according to claim 23, wherein the plant is designed to perform said sanitation of the waste water of the pre-washing means (B) and/or of the means for washing the containers (C) after sanitization of the process water stored in the at least one tank (1) for washing the fruit and vegetable produce (A).

26. The Plant according to claim 25 further comprising:
a tank (3) for storing sanitized water for performing pre-washing (B) and/or for washing the containers (C); and
a collection tank (4), for subsequent sanitization of the waste water from pre-washing (B) and/or washing (1C) of the containers (C).
